(19) United States
(12) Patent Application Publication
(10) Pub. No.: US 2026/0078940 A1
(43) Pub. Date: Mar. 19, 2026

(54) VEHICLE REFRIGERATOR

(71) Applicant: Anker Innovations Technology Co., Ltd., CHANGSHA (CN)

(72) Inventors: Cong HAN, SHENZHEN (CN); Qizhen OU, SHENZHEN (CN); Jiali ZHUANG, SHENZHEN (CN)

(21) Appl. No.: 19/403,229

(22) Filed: Nov. 28, 2025

Related U.S. Application Data
(63) Continuation-in-part of application No. PCT/CN2025/090955, filed on Apr. 24, 2025.

(30) Foreign Application Priority Data
Apr. 30, 2024 (CN) 202410540328.6
Apr. 30, 2024 (CN) 202420937576.X
May 17, 2024 (CN) 202421087565.3
Nov. 21, 2024 (CN) 202422851580.7

(51) Int. Cl. F25D 17/06; F25D 11/00

(52) U.S. Cl. CPC F25D 17/06; F25D 11/003

(57) ABSTRACT

The present application may provide a vehicle refrigerator. The vehicle refrigerator may include a cabinet, a door, a fan machine, and a refrigeration assembly. The cabinet may define a refrigeration cavity and a first opening. The first opening may be in communicating with the refrigeration cavity. The door may movably over the first opening. The fan machine may be arranged on a side of the door close to the refrigeration cavity. The refrigeration assembly may be mounted on the cabinet, and may be configured to cool the refrigeration cavity. The present disclosure may enhance cooling uniformity and cooling rate of the vehicle refrigerator.

### CROSS REFERENCE TO RELATED APPLICATIONS

This application is a continuation-in-part of International Patent Application No. PCT/CN2025/090955, filed on Apr. 24, 2025, which claims priority to the Chinese patent Application No. 202410540328.6 filed on Apr. 30, 2024, the Chinese patent Application No. 202420937576.X filed on Apr. 30, 2024, the Chinese patent Application No. 202421087565.3 filed on May 17, 2024, and the Chinese patent Application No. 202422851580.7 filed on Nov. 21, 2024, all of which are herein incorporated by reference in their entireties.

### TECHNICAL FIELD

The present disclosure relates to the field of vehicle refrigerator technologies, particularly to a vehicle refrigerator.

### BACKGROUND

With the continuous development of science and technology, vehicle refrigerators have increasingly appeared in human lives. Although inner walls of vehicle refrigerators of related art are usually equipped with refrigeration assemblies, convective air flow in the refrigeration cavity is weak, resulting in a relatively poor cooling effect.

### SUMMARY

The present disclosure may provide a vehicle refrigerator. The vehicle refrigerator may include a cabinet, a door, a fan machine, and a refrigeration assembly. The cabinet may define a refrigeration cavity and a first opening. The first opening may be in communicating with the refrigeration cavity. The door may movably over the first opening. The fan machine may be arranged on a side of the door close to the refrigeration cavity. The refrigeration assembly may be mounted on the cabinet, and may be configured to cool the refrigeration cavity.

### BRIEF DESCRIPTION OF THE DRAWINGS

To more clearly illustrate technical schemes in embodiments of the present disclosure or the related art, a brief introduction to the accompanying drawings required in the embodiments would be provided below. It may be obvious that, the accompanying drawings described below are merely some embodiments of the present disclosure. For those skilled in the art, additional drawings may be obtained based on these drawings without creative efforts.

FIG. 1 is a schematic structural diagram of an embodiment of a vehicle refrigerator of the present disclosure.

FIG. 2 is a schematic side view of the embodiment of FIG. 1.

FIG. 3 is a schematic structural diagram of an embodiment of a door and an axial flow fan of the present disclosure.

FIG. 4 is a schematic bottom view of the door and the axial flow fan of an embodiment of the present disclosure.

FIG. 5 is a schematic structural diagram of an embodiment of a door and a centrifugal fan of the present disclosure.

FIG. 6 is a schematic bottom view of an embodiment of the door and the centrifugal fan of the present disclosure.

FIG. 7 is a schematic structural diagram of another embodiment of the vehicle refrigerator of the present disclosure.

FIG. 8 is a schematic structural diagram of a cold air circulation cover plate of the present disclosure.

FIG. 9 is a schematic structural diagram of a cross section of the cold air circulation cover plate of the present disclosure.

FIG. 10 is a schematic structural diagram of another embodiment of a part of a structure of the vehicle refrigerator of the present disclosure.

FIG. 11 is a schematic structural diagram of yet another embodiment of a part of the structure of the vehicle refrigerator of the present disclosure.

FIG. 12 is a schematic diagram of the internal structure of the refrigerator provided by the embodiment of the present disclosure;

FIG. 13 is a schematic diagram of the structure of the door and the fan assembly provided by the embodiment of the present disclosure;

FIG. 14 is an exploded view of the door and the fan assembly provided by the embodiment of the present disclosure;

FIG. 15 is a schematic diagram of the internal structure of the door and the fan assembly provided by the embodiment of the present disclosure;

FIG. 16 is a cross-sectional view along the A-A direction in FIG. 13.

### DETAILED DESCRIPTION

The following would describe in detail and clearly the technical schemes of embodiments of the present disclosure in combination with the drawings. Obviously, the described embodiments are only a part of the embodiments of the present disclosure, not all of them. All other embodiments obtained by those of ordinary skills in the art without creative efforts based on the embodiments of the present disclosure may fall within the protection scope of the present disclosure.

It should be noted that, if the embodiments of the present disclosure involve a directional indication (such as up, down, left, right, front, rear . . . ), the directional indication may be only for explaining relative position relationships, motion, or the like among components under a particular posture (as illustrated in the drawings). If that particular posture changes, the directional indication may change accordingly.

Furthermore, if there are descriptions of “first”, “second”, or the like in the embodiments of the present disclosure, such descriptions of “first”, “second”, or the like are only for descriptive purposes, and should not be understood as indicating or suggesting relative importances or implicitly indicating a quantity of the technical features indicated. Therefore, the features preceded by “first”, “second” may explicitly or implicitly include at least one of the features. Additionally, the technical schemes of various embodiments may be combined with each other, but such combinations must be based on what may be implemented by a person of ordinary skills in the art. If a combination of technical schemes leads to contradictions or is unimplementable, it should be considered that such a combination does not exist, and is not within a protection scope claimed by the present disclosure.

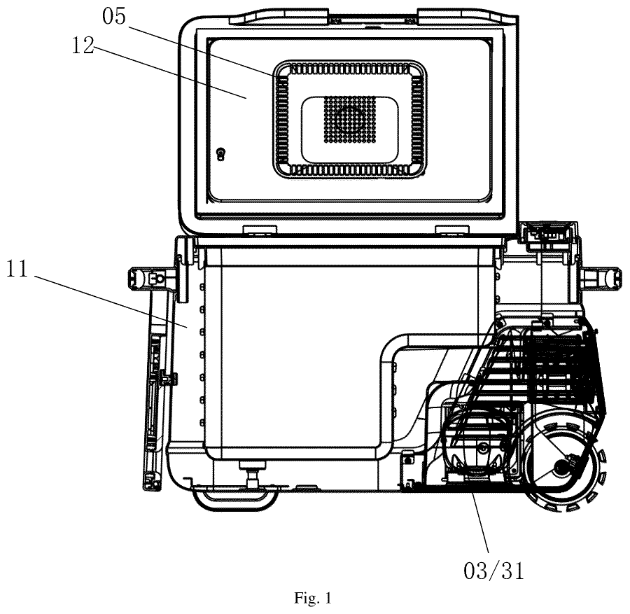

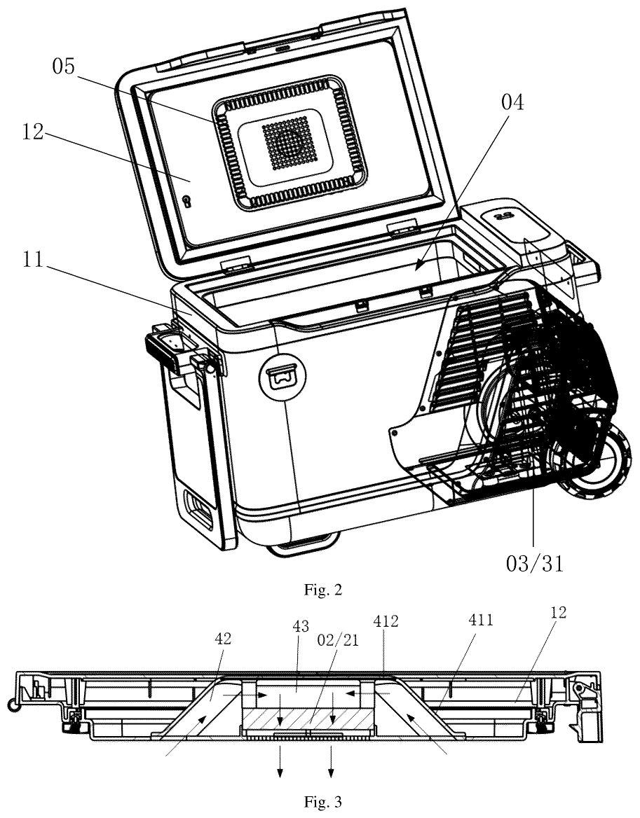

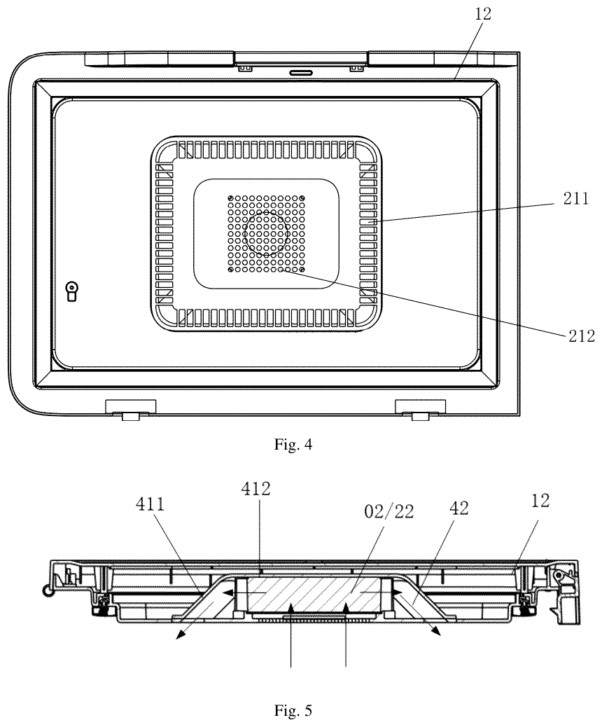

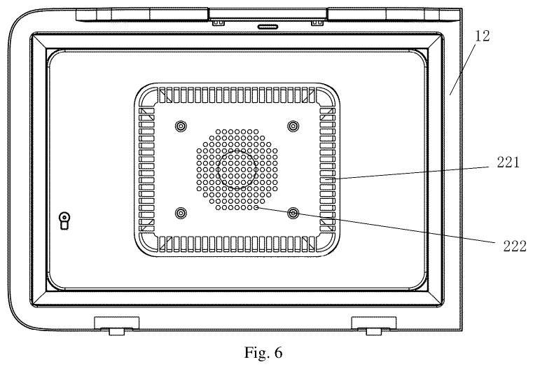

As illustrated in FIG. 1 to FIG. 6, the present disclosure may first propose a vehicle refrigerator. FIG. 1 may be a schematic structural diagram of an embodiment of the vehicle refrigerator of the present disclosure. FIG. 2 may be a schematic side view of the embodiment of FIG. 1. FIG. 3 may be a schematic structural diagram of an embodiment of a door and an axial flow fan of the present disclosure. FIG. 4 may be a schematic bottom view of the door and the axial flow fan of an embodiment of the present disclosure. FIG. 5 may be a schematic structural diagram of an embodiment of the door and the centrifugal fan of the present disclosure. FIG. 6 may be a schematic bottom view of an embodiment of the door and the centrifugal fan of the present disclosure. The vehicle refrigerator may include a cabinet 11, a door 12, a fan machine 02, and a refrigeration assembly 03. The cabinet 11 may define a refrigeration cavity 04 and a first opening. The first opening may be in communication with the refrigeration cavity 04. The door 12 may movably cover the first opening. The fan machine 02 may be arranged on a side of the door 12 close to the refrigeration cavity 04. The refrigeration assembly 03 may be mounted in the cabinet 11 to cool the refrigeration cavity 04.

Specifically, the fan machine 02 may operate within the refrigeration cavity 04. The fan machine 02 may be able to enhance convective effect of air flow within the refrigeration cavity 04. In this way, the air flow convective within the refrigeration cavity 04 may be enhanced without the necessity of being in communication with atmosphere air flow. Convective intensity may also be adjusted by regulating a wind force magnitude of the fan machine 02.

In some embodiments, the fan machine 02 may or may not operate in sync with the refrigeration assembly 03, which is not specifically limited here. Since the fan machine 02 can enhance the air flow convection in the refrigeration cavity 04, it is not necessary to define an air vent in communication with the atmosphere for the refrigeration cavity 04 in order to achieve a stronger air flow convection effect. For instance, during a production assembly process, the fan machine 02 and the refrigeration assembly 03 may be assembled separately. The refrigeration assembly 03 may operate independently to cool the refrigeration cavity 04. The fan machine 02 may operate independently to enhance the air flow convection effect inside the refrigeration cavity 04. Therefore, refrigeration approaches of the refrigeration assembly may be not limited herein in the present disclosure. For example, in one application scenario, as illustrated in FIG. 1, the refrigeration assembly 03 may include a refrigeration member 31 (e.g., a compressor) and an evaporator (not illustrated in the drawings). The refrigeration member 31 may include the compressor, a condenser, a condenser fan, or the like. The evaporator may be arranged outside the refrigeration cavity 04, and may achieve refrigeration of the refrigeration cavity 04 by cooling the cabinet 11.

For another example, in another application scenario (not illustrated in the drawings), the refrigeration assembly may also be a refrigeration case arranged inside the refrigeration cavity, which is not specifically limited here.

A beneficial effect of the aforementioned configuration may be that: the arrangement of the fan machine 02 may facilitate the air flow convective effect in the refrigeration cavity 04, thereby improving a cooling uniformity and a cooling rate in the refrigeration cavity 04, and thus enhancing the cooling effect. Further, the fan machine 02 may be arranged on the side of the door 12 close to the refrigeration cavity 04, which may be convenient for assembly and operation of the fan machine 02, and to enhance the air flow convection effect in the refrigeration cavity 04. The refrigeration assembly 03 may be mounted in the cabinet 11, which may be conducive to improving a positional stability of the refrigeration assembly 03, thereby enhancing the reliability of the vehicle refrigerator.

In some embodiments, an inner wall of the door 12 may define a recess. The recess may be in communication with the refrigeration cavity 04. The fan machine 02 may be at least partially arranged within a mounting cavity defined by the recess.

In some embodiments, the inner wall of the door 12 may define the recess in communication with the refrigeration cavity 04. By providing the fan machine 02 in the mounting cavity defined by the recess, an interference of the fan machine 02 to an available space within the refrigeration cavity 04 may be reduced, a stability of the fan machine 02 may be increased, and an influence of external interference on the fan machine 02 may be reduced. Further, the recess is defined by the inner wall of the door 12, a wall defining the recess may be integrally molded with the inner wall, which increases a stability of the recess.

In some embodiments, the fan machine 02 may be entirely mounted in the mounting cavity defined by the recess, to further increase an anti-interference performance of the fan machine 02 and an aesthetic appeal of the vehicle refrigerator.

In some embodiments, the fan machine 02 may be spaced apart from a side wall 411 of the recess, so as to define a first air duct 42 in communication with the refrigeration cavity 04.

The first air duct 42 may enhance a communication effect between the refrigeration cavity 04 and an air inlet and/or an air outlet of the fan machine 02, thereby increasing a convective enhancing effect of the fan machine 02 on the air flow within the refrigeration cavity 04. The fan machine 02 may be spaced apart from the side wall 411 of the recess, so as to define the first air duct 42, which is in communication with the refrigeration cavity 04. This design structure may be simple and does not require complex production design, thus a cost of production and assembly may be reduced.

In another embodiment, at least a part of the fan machine may be spaced apart from the side wall of the recess. A region of the fan machine, which is not spaced apart from the side wall of the recess, may be provided with a through hole communicating with the first air duct and with the refrigeration cavity.

In some embodiments, as illustrated in FIG. 3 and FIG. 4, the fan machine 02 may include an axial flow fan 21. The axial flow fan 21 may be spaced apart from a bottom wall 412 of the recess to define a second air duct 43. The second air duct 43 may be in communication with the air vent of the axial flow fan 21 and with the first air duct 42.

The design of an impeller and blades of the axial flow fan 21 may allow that, when the air flow flows out of the fan through the air outlet of the fan, the air flow may be almost parallel to rotational axis of the blades. The air inlet 211 and the air outlet 212 of the axial flow fan 21 may be arranged in a straight line parallel to the rotational axis of the blades. The axial flow fan 21 may be easily mounted. The definition of the second air duct 43 may enable the air inlet 211 of the axial flow fan 21 to be in communication with the first air duct 42 through the second air duct 43, and may be further in communication with the refrigeration cavity 04, thereby facilitating improvement of a blowing effect of the axial flow fan 21. The definition of the first air duct 42 and the second air duct 43 may facilitating the air flow to turn after passing through the first air duct 42, and then to enter the second air duct 43, thereby facilitating the air flow to enter the air inlet 211 of the axial flow fan 21. The second air duct 43 may be defined by arranging the axial flow fan 21 to be spaced apart from the bottom wall 412 of the recess, which may be simple in structure and convenient for production and mounting.

In some embodiments, a specific shape of the recess may be not limited. For example, the inner wall of the recess may be configured in a streamlined shape. In this way, an air guiding effect of an air duct may be improved, a resistance of the air duct may be reduced, and thereby saving power consumption.

In some embodiments, a connection portion between the side wall 411 of the recess and the bottom wall 412 of the recess may be arc-shaped or streamlined, which may improve a smoothness of the air flow while turning from the first air duct 42 to the second air duct 43 and may reduce drag.

In some embodiments, the side wall 411 of the recess and the bottom wall 412 of the recess are configured at an obtuse angle, so that an inner diameter of the recess may gradually increase along a direction from the bottom wall towards the refrigeration cavity 04, thereby facilitating the air flow to enter the axial flow fan 21 through the first air duct 42 and the second air duct 43.

In some embodiments, as illustrated in FIG. 5 and FIG. 6, the fan machine 02 may include a centrifugal fan 22. The side wall 411 of the recess and the bottom wall 412 of the recess may configured at an obtuse angle, so that the inner diameter of the recess may gradually increase along the direction from the bottom wall towards the refrigeration cavity 04.

The centrifugal fan 22 may be a type of fan that adopts the centrifugal force to deliver air. An operating principle of the centrifugal fan 22 may be: the air flow may be drawn into an interior of the fan through rotating impellers, then the air flow may be accelerated through the blades on the impeller, and the air flow may be pushed towards the air outlet through the centrifugal force, therefore delivery and pressurization of the air flow may be achieved. The centrifugal fan 22 may have a greater air pressure and flow rate, which may achieve a stronger convection effect. The air outlet 221 of the centrifugal fan 22 may be perpendicular to the air inlet 222, and the side wall 411 of the recess may be obtuse to the bottom wall 412 of the recess, such that the inner diameter of the recess may gradually increase along a direction from the bottom wall towards the refrigeration cavity 04, facilitating the diversion and deflection of the air flow discharged from the air outlet 221 of the centrifugal fan 22. In this way, an air pressure loss of the air flow, during a process of flowing from the air outlet 221 through the first air duct 42 to an outside of the mounting cavity, may be reduced, thereby improving the convective effect.

In some embodiments, a degree of the angle between the side wall 411 of the recess and the bottom wall 412 of the recess may be designed as required, and different degrees of the angle may achieve different diversion and deflection effects.

In some embodiments, the side wall 411 of the recess may also have a curved surface structure, capable of diverting the air flow discharged from the air outlet of the centrifugal fan 22 out of the mounting cavity defined by the recess.

In some embodiments, since the air outlet 221 of the centrifugal fan 22 may be perpendicular to the air inlet 222, an interval may not be provided between the centrifugal fan and the bottom wall 412 of the recess, so as to increase an integration degree of the vehicle refrigerator and improve a space utilization rate of the refrigeration cavity.

In some embodiments, the vehicle refrigerator may also include a first baffle 05. The first baffle 05 may be movably connected to the fan machine 02. The first baffle 05 may optionally cover at least part of an opening on the side of the first air duct 42 close to the refrigeration cavity 04.

In some embodiments, the first baffle 05 may be movably connected to the fan machine 02, and first baffle 05 may optionally cover at least part of the opening on the side of the first air duct 42 close to the refrigeration cavity 04. In this way, an air intake rate or air exhaust rate at that air outlet may be achieved by adjusting the first baffle 05, thereby enhancing a convenience of adjusting the air flow rate of the fan machine 02 and improving a user experience.

In some embodiments, as illustrated in FIG. 1, the vehicle refrigerator may also include the first baffle 05, the first baffle 05 may be movably connected to the inner wall of the door 12. The first baffle 05 may optionally cover at least part of the opening on the side of the first air duct 42 close to the refrigeration cavity 04.

In some embodiments, the first baffle 05 may be movably connected to the inner wall of the door 12 and selectively covers at least part of the opening on the side of the first air duct 42 close to the refrigeration cavity 04, allowing for the adjustment of the intake or exhaust volume at that outlet by adjusting the first baffle 05, thereby enhancing the convenience of adjusting the air volume of the fan machine 02 and improving the user experience.

In some embodiments, the refrigeration assembly 03 may be arranged outside the refrigeration cavity 04. The refrigeration assembly 03 may conduct heat transfer with the refrigeration cavity 04 through the cabinet 11.

In an application scenario, the refrigeration assembly 03 may be not in communication with the refrigeration cavity 04. A refrigeration of the refrigeration cavity 04 may be achieved through a refrigeration of the cabinet 11, which may facilitate the definition of a closed refrigeration cavity 04 by the cabinet 11, thereby enhancing a refrigeration and insulation effect within the refrigeration cavity 04. The structure is simple, and is easy to produce and assembly.

In some other embodiments, the refrigeration assembly may include the compressor, the condenser, the condenser fan, the evaporator and other refrigeration-related parts, which are arranged outside the refrigeration cavity. A cooling capacity may be transferred to the refrigeration cavity through a cooling cabinet of the evaporator. This heat conduction manner may mainly rely on natural convective heat transfer, which has a low heat transfer coefficient and a slow cooling rate. However, in the present disclosure, the fan machine may be arranged in the refrigeration cavity to enhance the air flow convective effect, thereby increasing the cooling rate and cooling uniformity.

In some embodiments, the vehicle refrigerator may also include an adapter. The adapter may be configured for detachable electrical connection to the refrigeration assembly 03 and/or the fan machine 02.

In an application scenario, an operating voltage of the vehicle refrigerator may be 12V DC. The adapter may convert alternating current (AC) to 12V direct current (DC). The adapter may connect to the refrigeration assembly 03 and/or the fan machine 02, thereby supplying power to the refrigeration assembly 03 and/or the fan machine 02.

This configured may enhance a multi-scenario adaptability of the vehicle refrigerator, improve the user experience, and achieve a detachable connection for easy storage.

In some embodiments, the vehicle refrigerator may also include a battery assembly. The battery assembly may achieve the electrical connection with the refrigeration assembly 03 and/or the fan machine 02. In this way, a portability of the vehicle refrigerator may be increased, and the user experience may be increased.

In some embodiments, the fan machine 02 may include a start switch. The user may manually control the fan machine 02 to turn on and turn off through the start switch. Further, the fan machine 02 may also include a wind force adjustment switch for user control, thereby facilitating energy conservation.

In some embodiments, the vehicle refrigerator may include a handle. The handle may be arranged on the cabinet 11. The handle may facilitate the users to move the vehicle refrigerator and may enhance the user experience.

In some embodiments, the refrigeration assembly 03 may include the compressor, the condenser, a capillary tube, the evaporator, the condenser fan, a door fan and other refrigeration-related components, so as to achieve cooling of the refrigeration cavity 04.

In some embodiments, the cabinet 11 may be provided with a power supply interface. The power supply interface may be arranged on the cabinet 11. The refrigeration assembly 03 and/or the fan machine 02 may be electrically connected to an external power supply system via the power supply interface. The power supply interface may be electrically connected to the external power supply system, such as a vehicle-mounted charger, so as to supply power to the refrigeration assembly 03 and/or the fan machine 02.

In some embodiment, the vehicle refrigerator may include a controller. The controller may be electrically connected to the battery assembly, the power supply interface or the adapter, and the fan, the compressor, the condenser fan, or the like, so as to control operation of these components.

In some embodiments, the vehicle refrigerator may be powered by a 12V/24V power supply of a car charger inside the vehicle.

Different from the related art, the vehicle refrigerator of the present disclosure may include the cabinet, the door, the fan machine, and the refrigeration assembly. The cabinet may define the refrigeration cavity and the first opening. The first opening may be in communication with the refrigeration cavity. The door may cover the first opening. The fan machine may be arranged on the side of the door close to the refrigeration cavity. The refrigeration assembly may be mounted in the cabinet for cooling the refrigeration cavity. The fan machine may be arranged to enhance the air flow convective effect in the refrigeration cavity, thereby improving the cooling uniformity and cooling rate in the refrigeration cavity, and improving the cooling effect. Further, the fan machine may be arranged on the side of the door close to the refrigeration cavity, thereby facilitating assembly and operation of the fan machine. By arranging the fan machine on the side of the door close to the refrigeration cavity, the air flow convection effect in the refrigeration cavity may be enhanced. The refrigeration assembly may be mounted in the cabinet, thereby facilitating increasing of the positional stability of the refrigeration assembly, and thereby enhancing the reliability of the vehicle refrigerator.

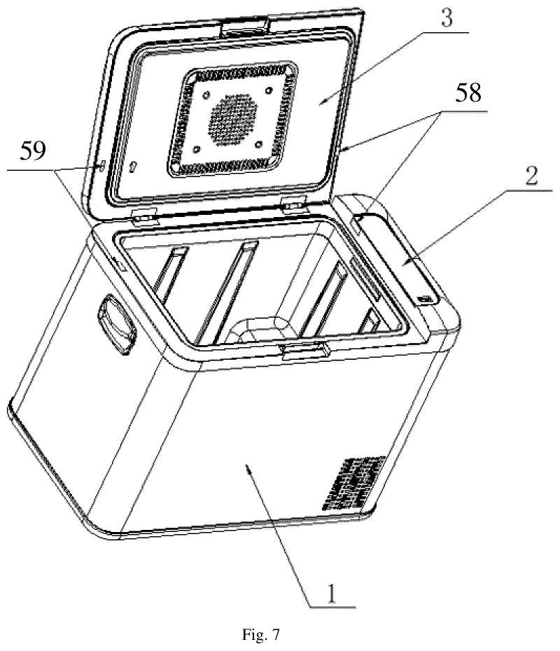

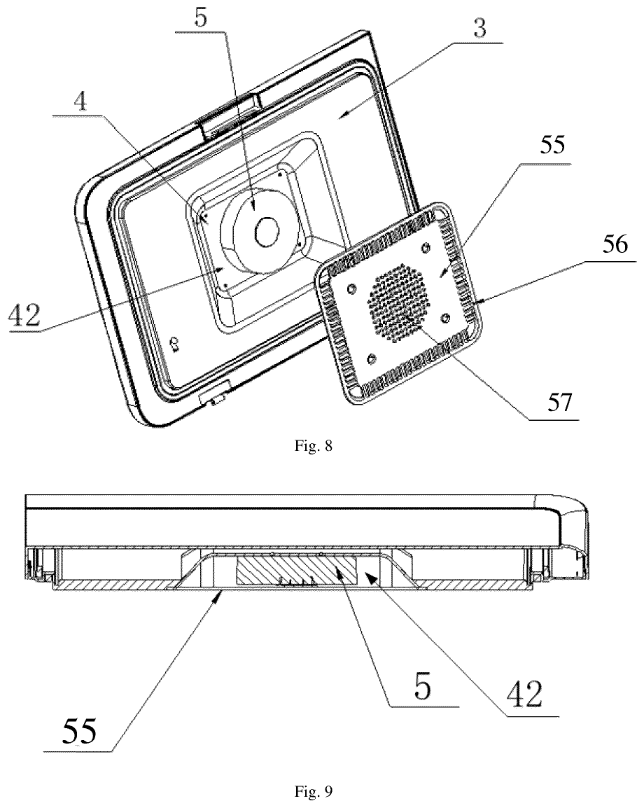

It should be noted that, in any embodiment corresponding to the implementation as illustrated in the aforementioned FIG. 1 to FIG. 6, similar modification may be made to the vehicle refrigerator by referring to any embodiment corresponding to the implementation as illustrated in FIG. 7 to FIG. 11 below.

For example, in the implementation corresponding to FIG. 7 to FIG. 11 below, a circulating fan 5 may be capable of providing power for the air flow. In the aforementioned embodiments, the fan machine 02 may be capable of providing power for the air flow. The fan machine 02 in any of the aforementioned embodiments may be modified by referring to the specific implementation of relevant technical features in the following embodiments. The relevant technical features may be such as the operation principle, connection with other components of the circulating fan 5, or the like. For another example, in the following embodiments, a cold air circulation cover plate 3 may be configured to setup the circulating fan 5. In the aforementioned embodiments, the door 12 may be configured to setup the fan machine 02 The door 12 in any of the aforementioned embodiments may be modified by referring to the specific implementation of the relevant technical features in the following embodiments. The relevant technical features may such as be the operating principle, connection with other components of the cold air circulation cover plate 3 or the like. For reference, other modifications to the vehicle refrigerator would not be elaborated here.

In any of the following embodiments, similar modification may be made to the vehicle refrigerator by referring to any embodiment corresponding to the implementation as illustrated in the aforementioned FIG. 1 to FIG. 6. This would not be elaborated here.

In the related art, the vehicle refrigerator may refer to a freezer that may be carried in a car. The vehicle refrigerator may be a new generation of refrigeration and cold storage appliances that have become popular in the international market in recent years. Generally, the vehicle refrigerator may be a compressor vehicle refrigerator. The compressor may be a traditional technology of traditional refrigerators. The compressor may have a low cooling temperature ranging from −18 degrees to 10 degrees. The compressor may have a high cooling efficiency, may make ice and keep food fresh, and may have a large volume. The compressor may be also a development trend of the vehicle refrigerator in the future.

The related art may have the following deficiencies: when the vehicle refrigerator of the related art is in use, the cold air produced after cooling may generally flows slowly in the refrigeration cavity and a chill compartment. This makes it inconvenient for the cold air to circulate rapidly in the refrigeration compartment through rapid air flow, resulting in low cooling efficiency, which may be not conducive to increasing the cooling efficiency under a same operation power, and may be not conducive to rapid diffusion and heat exchange of the cold air.

The present disclosure may further propose a vehicle refrigerator as illustrated in FIG. 7 to FIG. 9. The specific implementation mode may adopt the following technical scheme: the vehicle refrigerator may include a vehicle refrigerator body 1, a side panel 2, and the cold air circulation cover plate 3. An inwardly-concave air-inducing chamber 4 may be defined at a middle of an inner side of the cold air circulation cover plate 3. The circulating fan 5 may be fixed in the middle of the inwardly-concave air-inducing chamber 4. The inwardly-concave air-inducing chamber 4 may be equivalent to the recess in the aforementioned embodiments. The cold air circulation cover plate 3 may be equivalent to the door 12 in those embodiments.

In some embodiments, as illustrated in FIG. 8, a second baffle 55 may be fixed to a surface of the inwardly-concave air-inducing chamber 4. An outer edge of the second baffle 55 may be provided with a perimeter of air-intake grilles 56. A middle of the second baffle 55 may be provided with air outlet holes 57 distributed in a matrix pattern. The air outlet holes 57 may keep in contact with air outlets in a middle of the circulating fan 5. The air-intake grilles 56 may be in communication with the inwardly-concave air-inducing chamber 4.

Specifically, as illustrated in FIG. 8, in some embodiments, the vehicle refrigerator may also include the second baffle 55. The second baffle 55 may cover the opening of the recess (the inwardly-concave air-inducing chamber 4) that may be defined on the inner wall of the door (cold air circulation cover plate 3). The fan machine (equivalent to the circulating fan 5) may be arranged in the recess. An outer periphery of the second baffle 55 may be provided with air-intake grilles 56 in communication with the recess. The air outlet holes 57, which are in communication with the air outlets, may be defined at the middle of the second baffle 55. Further, the air-intake grilles 56 may be arranged to surround the air outlet holes 57. Further, the air outlet holes 57 may be arranged to keep in close contact with the air outlets in the middle of the fan machine. In other words, the air outlet holes 57, which are in communication with both the air outlet of the fan machine and the refrigeration cavity, may be defined in a region where the fan machine may be attached to the second baffle 55.

The fan machine (the circulating fan 5) may be arranged at least partially spaced apart from a side wall of the recess to define the first air duct 42. The air flow may pass through the air-intake grilles 56, in sequence through the first air duct 42, the air inlet of the fan machine, the air outlet in the middle of the fan machine, and the air outlet holes 57 distributed in the matrix pattern, and enter the refrigeration cavity. It may be determined that, the first air duct 42 may be in communication with the air inlet of the fan machine and the air-intake grilles 56.

In some embodiments, the circulating fan 5 may be a drum-type turbine structure with a lateral-suction and bottom-discharge structure.

In some embodiments, as illustrated in FIG. 7, an inductive sensor 58 may be provided on one side of the cold air circulation cover plate 3. The inductive sensor 58 may be in inductive cooperation with the side panel 2, so as to achieve start and stop control of the circulating fan 5. An inner edge of the cold air circulation cover plate 3 may be also provided with a second inductive sensor 59. The second inductive sensor 59 may be connected to a Logo light and other electronic control devices.

Specifically, as illustrated in FIG. 7, in some embodiments, the vehicle refrigerator may also include the inductive sensor 58. The inductive sensor 58 may be arranged on one side of the door (the cold air circulation cover plate 3), and may be configured to control the start and stop of the fan machine (the circulating fan 5).

Furthermore, the vehicle refrigerator may include the cabinet and the door (the cold air circulation cover plate 3). The cabinet may include a main body 1 of the vehicle refrigerator and the side panel 2. The inductive sensor 58 may operate in inductive cooperation with the side panel 2, so as to control the start and stop of the fan machine (the circulating fan 5).

Furthermore, the vehicle refrigerator may also include the second inductive sensor 59 and a second electronic control device (equivalent to the aforementioned Logo light or other electronic control devices). The second inductive sensor 59 may be arranged on the inner edge of the door (the cold air circulation cover plate 3), and may be configured to control the start and stop of the second electronic control device.

In addition, in some embodiments, a sealing gasket ring may be provided between the air outlet of the circulating fan 5 and the air outlet hole 57, so as to achieve the isolation of the air-intake grilles 56 and the air outlet holes 57. In some embodiments, a back of the second baffle 55 may be provided with four sets of extended connecting column, which may match with bolts to fix the second baffle 55 to the inwardly-concave air-inducing chamber 4.

Specifically, in some embodiments, the vehicle refrigerator may also include the sealing gasket ring. The sealing gasket ring may be arranged between the air outlet of the fan machine (the circulating fan 5) and the air outlet hole 57, and may be configured to isolate the air-intake grilles 56 from the air outlet hole 57.

In some embodiments, one side of the sealing gasket ring may abut against a side of the fan machine close to the second baffle 55, and another side of the sealing gasket ring may abut against the second baffle 55. The sealing gasket ring may surround the air outlet holes 57 and the air outlet of the fan machine. The sealing gasket ring may be capable of isolating the air-intake grilles 56 from the air outlet hole 57, thereby reducing interference to exhaust from the air outlet hole 57.

Further, in some embodiments, air inlet and outlet approach of the air outlet holes 57 and the air-intake grilles 56 may be circulated in a reverse direction by a reverse drive of the circulating fan 5. In other words, when the circulating fan 5 is driven in reverse, the air outlet holes 57 may be configured as an air intake side and the air-intake grilles 56 may be configured as an air exhaust side.

The operating principle of the specific implementation may be as follows: the compressor inside the main body 1 of the vehicle refrigerator may cooperate with the evaporator to cool an interior of the cabinet. Then, the circulating fan 5 may blow air to the middle of the main body 1 of the vehicle refrigerator, thereby causing the cold air to rise from the periphery, and may enter the interior of the circulating fan 5 through the air-intake grilles 56 to define an internal circulation. In this way, the cold air deposited at the bottom may be allowed to fill the entire chill chamber.

The beneficial effect of the specific implementation adopting the aforementioned structure may be that: by mounting the circulating fan on the refrigerator door panel, the flow rate of the cold air in the chill compartment may be increased, the cooling efficiency may be enhanced. By adopting a design of wide air-intake and narrow air-exhaust, an initial velocity at the cold air outlet may be increased, thereby expanding a cold air circulating range. At the same time, sufficient air intake may prevent air noise due to drawing in the cold air.

The present disclosure may further propose a vehicle refrigerator as illustrated in FIG. 7 to FIG. 11.

### First Specific Implementation

As illustrated in FIG. 7-FIG. 9, the present specific implementation may adopt the following technical scheme. The vehicle refrigerator may include the main body 1 of the vehicle refrigerator, the side panel 2, and the cold air circulation cover plate 3. The inwardly-concave air-inducing chamber 4 may be defined at the middle of the inner side of the cold air circulation cover plate 3. The circulating fan 5 may be fixed in the middle of the inwardly-concave air-inducing chamber 4. The second baffle 55 may be fixed on the surface of the inwardly-concave air-inducing chamber 4. A perimeter of the air-intake grille 56 may be provided on the outer edge of the second baffle 55. The air outlet holes 57 distributed in a matrix pattern may be defined in the middle of the second baffle 55. The air outlet holes 57 may keep in contact with the air outlets in the middle of the circulating fan 5. The air-intake grilles 56 may be in communication with the inwardly-concave air-inducing chamber 4.

In some embodiments, the circulating fan 5 may be a drum-type turbine structure with the lateral-suction and bottom-discharge structure. In some embodiments, the inductive sensor 58 may be provided on one side of the cold air circulation cover plate 3. The inductive sensor 58 may be in inductive cooperation with the side panel 2, so as to realize the start and stop control of the circulating fan 5. The second inductive sensor 59 may be further provided on the inner edge of the cold air circulation cover plate 3. The second inductive sensor 59 may be connected to the Logo light or other electronic control devices.

In addition, in some embodiments, the sealing gasket ring may be provided between the air outlet of the circulating fan 5 and the air outlet holes 57, so as to isolate the air-intake grilles 56 from the air outlet holes 57. In some embodiments, four sets of extended connecting columns matching bolts may be provided on the back of the second baffle 55, so as to fix the second baffle 55 to the inwardly-concave air-inducing chamber 4.

The operating principle of the specific implementation may be as follows: the compressor in the main body 1 of the vehicle refrigerator may cooperate with the evaporator to cool the interior of the cabinet. Then, the circulating fan 5 may blow air to the middle of the main body 1 of the vehicle refrigerator, causing the cold air to rise from all around, and to enter the interior of the circulating fan 5 through the air-intake grilles 56, so as to form the internal circulation. In this way, the cold air deposited at the bottom may fill the entire chill compartment.

The beneficial effect of the specific implementation adopting the aforementioned structure may be that: by mounting the circulating fan on the refrigerator door panel, the flow rate of the cold air in the chill compartment may be increased, the cooling efficiency may be enhanced. By adopting the design of wide air-intake and narrow air-exhaust, the initial velocity at the cold air outlet may be increased, thereby expanding the cold air circulating range. At the same time, sufficient air intake may prevent the air noise due to drawing in the cold air.

### Second Specific Implementation

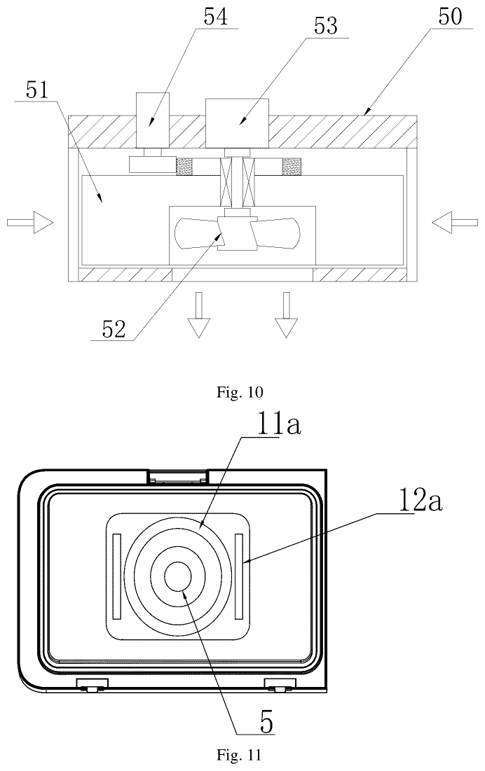

As illustrated in FIG. 10 and FIG. 11, the difference between the present specific implementation and the first specific implementation may be that: the circulating fan 5 may be replaced with a dual fan 50, and an ultraviolet lamp 11a and a semiconductor auxiliary cooling fin 12a may be added in the inwardly-concave air-inducing chamber 4. The dual fan 50 may include a turbine fan 51, a blade fan 52, a first drive motor 53, and a second drive motor 54. The turbine fan 51 may be provided inside the dual fan 50. The blade fan 52 may be embedded in a reserved slot at the middle of the turbine fan 51. A transmission shaft of the blade fan 52 may pass through a middle bearing of the turbine fan 51 and connect with the first drive motor 53. The turbine fan 51 may connect with the second drive motor 54 through a transmission gear disc at an upper end of the turbine fan 51. In some embodiments, the turbine fan 51 and the blade fan 52 may keep rotating at a constant speed, and a rotation speed of the blade fan 52 may be greater than or equal to that of the turbine fan 51. The turbine fan 51 may maintain a large flow rate at a low rotation speed, and the blade fan 52 may operate at a high speed to supplement air pressure. Through this arraignment, the air flow may be stabilized, and turbulence may be reduced.

Specifically, in the present embodiment, a part equivalent to the fan machine of the vehicle refrigerator may include the turbine fan 51. The turbine fan 51 may be provided inside the dual fan 50. The blade fan 52 may be provided in the reserved slot in the middle of the turbine fan 51. The first drive motor 53 may be in transmission connection with the blade fan 52. The second drive motor 54 may be in transmission connection with the turbine fan 51.

Further, in some embodiments, as illustrated in FIG. 11, a ring of ultraviolet lamps 11a may be provided in the middle of the inwardly-concave air-inducing chamber 4. The ultraviolet lamps 11a may be sleeved on an outside of the circulating fan 5. A pair of semiconductor auxiliary cooling fins 12a may be respectively provided on the left side and the right side of the inwardly-concave air-inducing chamber 4. A temperature of the semiconductor auxiliary cooling fins 12a may be controlled between 0-4 degrees. One of the pair of semiconductor auxiliary cooling fins 12a may correspond to one of the air-intake grilles 56 on the left side and the right side of the second baffle 55, and another of the pair of semiconductor auxiliary cooling fins 12a may correspond to another of the air-intake grilles 56 on the left side and the right side of the second baffle 55.

Specifically, in the present embodiment, as illustrated in FIG. 11, the vehicle refrigerator may further include the ultraviolet lamp 11a provided in the recess (the inwardly-concave air-inducing chamber 4), and the ultraviolet lamp 11a may be sleeved on the outside of the fan machine (the circulating fan 5).

Further, as illustrated in FIG. 11, the vehicle refrigerator may further include the semiconductor auxiliary cooling fin 12a provided in the recess (the inwardly-concave air-inducing chamber 4). Further, the vehicle refrigerator may include two semiconductor auxiliary cooling fins 12a oppositely provided on both sides of the fan machine. Further, the temperature of the semiconductor auxiliary cooling fins 12a may be controlled between 0-4 degrees. Further, the semiconductor auxiliary cooling fins 12a may be arranged corresponding to the air-intake grilles 56. It may be determined that, this arrangement may facilitate auxiliary cooling of the air flow entering the recess by using the semiconductor auxiliary cooling fins 12a.

The beneficial effect of the present specific implementation adopting the aforementioned structure may be: the circulating air may be controlled through the dual fan structure, a circulation speed may be increased, and functions of sterilization and auxiliary cooling may be added.

### Third Specific Implementation

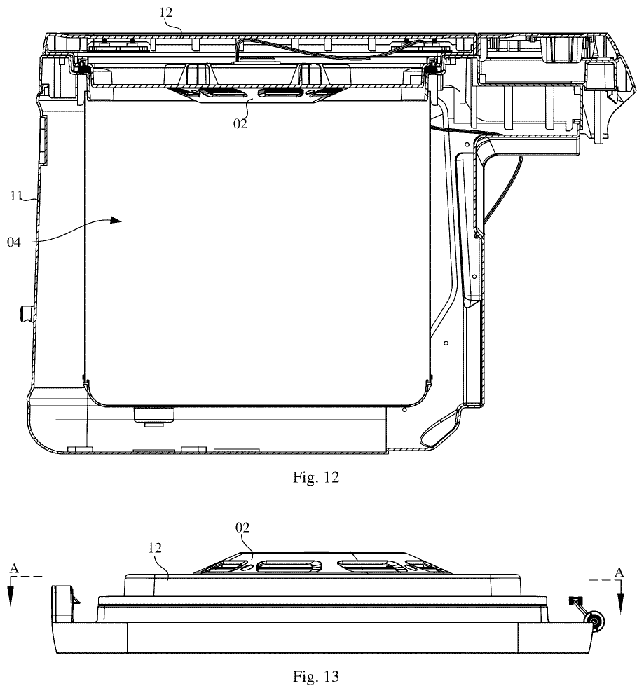

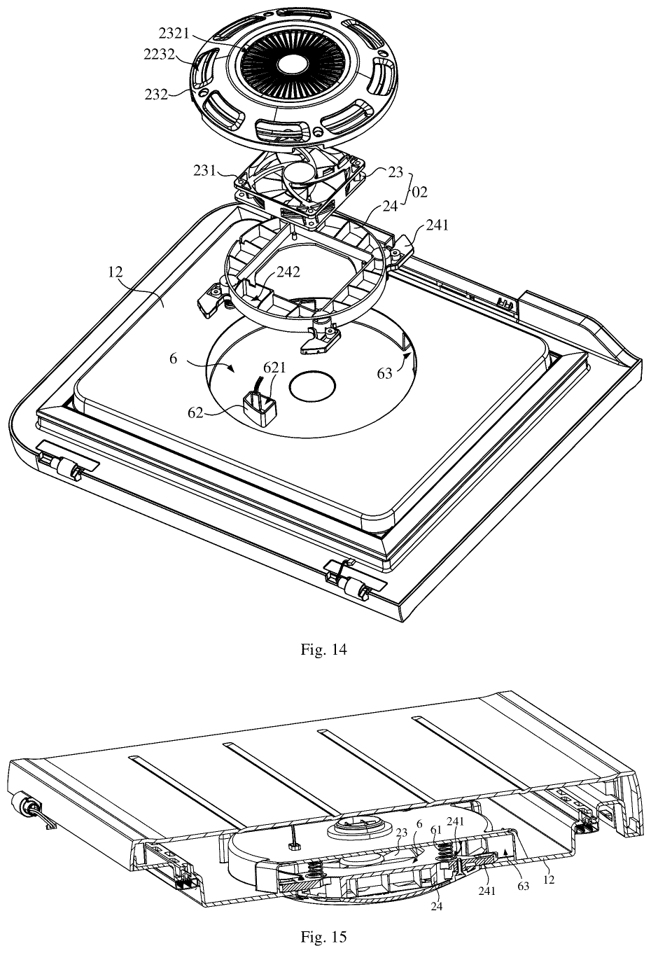

As illustrated in FIG. 12 to FIG. 14, another refrigerator may be provided. Inside the refrigerator, the air-cooling circulation may be enhanced, rapid temperature balance may be enabled, thereby reducing the energy consumption of the refrigerator. FIG. 12 is a schematic diagram of an internal structure of the refrigerator according to some embodiments of the present disclosure. FIG. 13 is a schematic structural diagram of a structure of a door and a fan assembly according to some embodiments of the present disclosure. FIG. 14 is an exploded view of the door and the fan assembly according to some embodiments of the present disclosure.

The refrigerator in the present embodiment may be a household refrigerator (such as a single-door refrigerator, a double-door refrigerator, a multi-door refrigerator, or the like), a commercial refrigerator (such as a supermarket freezer, a restaurant refrigerator, or the like) and a portable refrigerator. A portable refrigerator may be a small refrigeration device that is easy to carry and may provide refrigeration or freezing functions in a mobile state. The following description will be performed with the refrigerator of the present embodiment as a portable refrigerator as an example.

The refrigerator may include a cabinet 11, a door 12 and a fan machine 02. The fan machine 02 may also be referred to as a fan assembly. The cabinet 11 may be used as an outer shell support structure of the entire refrigerator, and may adopt a hollow cuboid structure. The cabinet 11 may be made of high-strength materials, such as stainless steel, which has good heat insulation performance and durability. A refrigeration cavity 04 may be defined inside the cabinet 11. The refrigeration cavity 04 may be a fresh-keeping compartment, a refrigerating compartment, a freezing compartment, etc. of the refrigerator. The refrigeration cavity 04 may also be referred to as a storage compartment. A space size of the refrigeration cavity 04 may depend on a designed capacity of the refrigerator. The refrigeration cavity 04 may have good thermal insulation performance. Four walls of the refrigeration cavity 04 may be made of high-efficiency thermal insulation materials, which may effectively reduce cold energy loss. Shelves or partitions for placing items may be arranged inside the refrigeration cavity 04 to facilitate users to store different types of refrigerated items in categories.

In the present disclosure, the door 12 may be movably connected to the cabinet 11. The connection may be a drawer-type sliding connection or a rotatable connection. For example, the door may be rotationally connected to the cabinet 11 through a door hinge. A sealing component may be provided at a part of the door 12 in contact with the cabinet 11, so as to ensure a tightness of the refrigeration cavity 04 when the door 12 is closed. A mounting cavity 6 is defined on an inner wall of the door 12. The mounting cavity 6 may be equivalent to the above-mentioned recess. An opening of the mounting cavity 6 may face the refrigeration cavity 04. The shape and size of the mounting cavity 6 may be adapted to the fan machine 02, so as to provide a stable installation position for the fan machine 02.

The fan machine 02 may be mounted in the mounting cavity 6 of the door 12, and may partially extend out of the opening of the mounting cavity 6. The fan machine 02 may be composed of a low-power motor and thin fan blades, which may provide stable and continuous air flow while reducing a weight of the fan machine 02. When the fan machine 02 starts to operate, it may blow air towards the refrigeration cavity 04, and the blown air may form an all-round air-cooling circulation in the refrigeration cavity 04. After the air flow is blown out from the fan machine 02, it may quickly spread in the refrigeration cavity 04 and take away heat from all positions in the refrigeration cavity 04. For example, the air flow may flow along the inner wall of the refrigeration cavity 04, pass through the shelves where food is placed, and bypass the stored items, such that the temperature difference in the entire refrigeration cavity 04 may be quickly reduced, and rapid temperature equilibrium may be achieved. Compared with a traditional natural convection approach, the present embodiment may more effectively distribute the cold energy evenly to every corner of the refrigeration cavity 04.

In the related art, when the user puts new items in the refrigeration cavity 04 or opens the door 12 frequently, the temperature of the refrigeration cavity 04 may fluctuate greatly, and a compressor of the refrigerator may need to operate continuously for a long time, so as to restore a set temperature. However, in the present embodiments, under an action of the fan machine 02, the temperature fluctuation may be adjusted in a short time, thereby reducing an operating time length of the compressor. A significant reduction in the operating time length of the compressor may lead to reduction of an energy consumption of the refrigerator, thereby greatly improving a battery life of the refrigerator. For a portable refrigerator, better battery life may mean that, users do not have to frequently worry about insufficient power of the refrigerator in mobile use scenarios such as outdoor travel and camping, and may keep the refrigerated items at a suitable temperature for a longer time, providing great convenience for the users.

In order to accelerate a temperature equilibrium process inside the refrigeration cavity 04, the opening of the mounting cavity 6 of the present embodiment may be vertically upward, and the door 12 may be located at the top of the cabinet 11. In this way, the air flow generated by the fan machine 02 may blow from above towards a bottom of the refrigeration cavity 04. Since hot air is relatively light and may rise naturally, and cold air is relatively heavy and may sink naturally, the air flow blown from above by the fan machine 02 may conform to this natural convection law and more effectively promote the air circulation in the refrigeration cavity 04. Compared with blowing in a horizontal direction, this top-to-bottom air flow may quickly bring the cold air above to the bottom, make the temperature in the refrigeration cavity 04 more uniform, accelerate the air-cooling circulation speed, thereby further reducing the time length required for temperature equilibrium, reducing the operation time and energy consumption of the compressor, and increasing the battery life of the refrigerator.

In addition, the fan machine 02 of the present embodiment may partially extend out of the opening of the mounting cavity 6 of the door 12. Compared with a method of completely embedding the fan machine 02 in the door 12 in the related art, the present embodiment may effectively reduce a thickness of the door 12. The reduction in the thickness of the door 12 may increase the refrigeration space without affecting an overall structural strength and function of the refrigerator. In this way, the user may store more food or other items that need refrigeration, increasing the practicability and the user experience of the portable refrigerator.

As illustrated in FIGS. 14 and 15. FIG. 15 is a schematic diagram of the internal structure of the door 12 and the fan machine 02 according to some embodiments of the present disclosure.

In some embodiments, the fan machine 02 may be movably connected to the door 12, and may be configured to extend from the opening into the refrigeration cavity 04 and retract from the opening into the mounting cavity 6. Specifically, the fan machine 02 may include a bracket 24 and a fan 23. The fan 23 may be connected to the bracket 24. The bracket 24 may be movably connected to the door 12 in the mounting cavity 6. The fan 23 may be fixedly connected to the bracket 24, for example, by screw connection or snap connection.

The fan machine 02 and the door 12 may be connected through the following movable connection approaches. In a first movable connection approach, the fan machine 02 and the door 12 may be connected through a guide rail slider. Sliders may be provided on both sides of the bracket 24, and the guide rails may be provided on the corresponding inner walls of the mounting cavity 6. The sliders and the guide rails may cooperate with each other, such that the bracket 24 may slide within a certain range along the guide rails, thereby realizing extension and retraction of the fan machine 02. This connection approach may ensure a smooth movement of the fan machine 02, and may bear a certain lateral force to prevent the fan machine 02 from shifting during movement. In a second movable connection approach, the fan machine 02 and the door 12 may be connected through a telescopic sleeve. The telescopic sleeve structure may be arranged between the bracket 24 and the mounting cavity 6 wall. The telescopic sleeve may include an inner sleeve and an outer sleeve. The inner sleeve may be connected to one of the brackets 24 and the mounting cavity 6 wall, and the outer sleeve may be connected to another of the bracket 24 and the mounting cavity 6 wall. The inner sleeve may be capable of free telescoping within the outer sleeve, thereby realizing the telescopic movement of the fan machine 02. This connection approach may provide good stability and sealing, and may adapt to different telescopic length requirements.

The refrigerator may further include an elastic member 61. One end of the elastic member 61 may be connected to the bracket 24, and another end may be connected to the mounting cavity 6 wall. In the present embodiment, the elastic member 61 may assist the fan machine 02 in telescopic movement and resetting. The elastic member 61 may be a spring (such as a coil spring or a leaf spring) or a rubber element with elastic restoring ability.

An accommodation recess 241 may be arranged on a side of the bracket 24 away from the opening of the mounting cavity 6. One end of the elastic member 61 may be arranged in the accommodation recess 241. The design of the accommodation recess 241 may prevent the elastic member 61 from lateral displacement when compressed, thereby increasing the operating stability of the elastic member 61. Another end of the elastic member 61 may abut against the bottom wall of the mounting cavity 6. When the fan machine 02 retracts into the mounting cavity 6, the elastic member 61 may be compressed. When an external force exerted on the fan machine 02 disappears, an elastic restoring force of the elastic member 61 may push the fan machine 02 to extend into the refrigeration cavity 04, and return to its original position. In some embodiments, four elastic members 61 may be provided, and the four elastic members 61 may be arranged at intervals at the bottom of the bracket 24, so as to provide more stable elastic force and support.

In some embodiments, the fan machine 02 may extend from the opening into the refrigeration cavity 04, and retract from the opening into the mounting cavity 6. When it is necessary to open or close the door 12, or to adjust position of items in the refrigeration cavity 04, the fan 23 with a fixed position in the related art may collide with these items, resulting in damage to the items or the fan 23. However, the fan machine 02 in the present embodiment may be telescopic, so when encountering an obstacle or approaches items in the refrigeration cavity 04, the fan machine 02 may retract into the mounting cavity 6 to avoid collision. For example, when a user places a tall bottle in the refrigeration cavity 04, the fan machine 02 may retract as soon as it touches the bottle, thereby protecting the bottle and the fan machine 02.

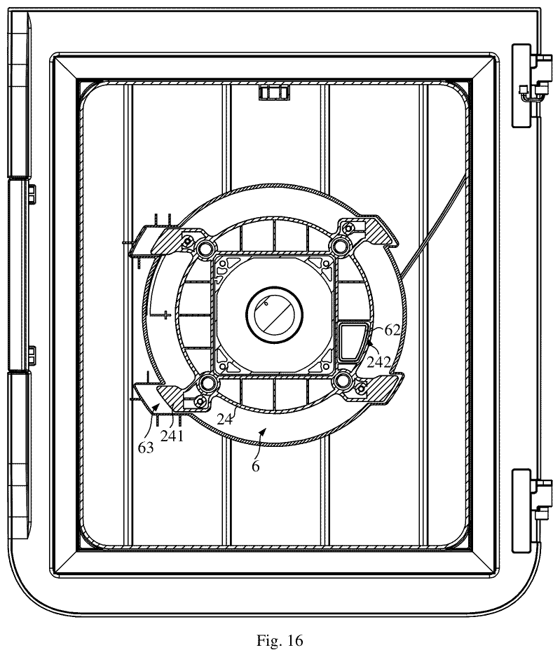

As illustrated in FIGS. 14, 15 and 16. FIG. 5 is a cross-sectional view along the A-A direction in FIG. 13.

In some embodiments, the fan 23 may be connected to the bracket 24. The bracket 24 may play a critical role in supporting the fan 23 and realizing the connection with the mounting cavity 6 of the door 12. The bracket 24 may be circular as a whole. A design shape of the bracket 24 may match the mounting cavity 6, so as to ensure good adaptability and stability. A limit arm 241 may be arranged on an edge of the bracket 24, and the limit arm 241 may be configured to cooperate with a limit groove 63 of the mounting cavity 6, so as to realize positioning and installation of the fan machine 02 in the mounting cavity 6 of the door 12.

In some embodiments, there are a plurality of limit arms 241. The plurality of limit arms 241 may be arranged at intervals on the edges of the opposite sides of the bracket 24. In some embodiments, the number of the limit arms 241 may be specifically four. Each of the two opposite side edges of the bracket 24 may be provided with two limit arms 241 that are arranged at intervals. The side wall of the mounting cavity 6 may define limit grooves 63 for the limit arms 241 to insert. The limit grooves 63 may be arranged in one-to-one correspondence with the limit arms 241, so as to ensure accurate installation and positioning of the fan machine 02 in the mounting cavity 6. Further, in a length extending direction of the limit arm 241, a depth of the limit groove 63 on one side of the mounting cavity 6 may be greater than that of the limit groove 63 on another side of the mounting cavity 6. The design of this depth difference is one of the key innovations of the present embodiment, which may facilitate an installation and adjustment of the fan machine 02.

The following is an illustration of the installation process and the principle of the fan machine 02.

When installing the fan machine 02 in the mounting cavity 6 of the door 12, first align and insert the two limit arms 241 on one side of the bracket 24 into the two limit grooves 63 with greater depth on one side of the mounting cavity 6. During the insertion process, the limit grooves 63 with greater depth may provide initial guidance and positioning for installation, making the installation process easier and more accurate. After the two limit arms 241 are completely inserted into the two limit grooves 63 with greater depth, the two limit arms 241 on another side of the bracket 24 may move towards another side of the mounting cavity 6, such that the other two limit arms 241 may be gradually inserted into the matched limit grooves 63. In this way, by using the depth difference of the limit grooves 63, the fan machine 02 may be skillfully mounted step by step and accurately in the mounting cavity 6.

Through the above-mentioned installation approach, the cooperation between the limit arms 241 and the limit grooves 63 may be used to realize precise positioning of the fan machine 02 in multiple directions. Compared with installation approaches in the related art such as simple clamping grooves or screw fixing, the cooperation between the limit arms 241 and the limit grooves 63 with different depths may install the fan machine 02 at predetermined positions accurately, and an error may be controlled within a very small range, thereby improving the installation accuracy.

The plurality of limit arms 241 and the matched limit grooves 63 may limit the bracket 24 in different directions, which effectively increases a stability of the fan machine 02 in the mounting cavity 6. In daily usage of the portable refrigerator, especially during movement, the refrigerator may be subject to various vibrations and jolts. The installation approach in the related art may cause the fan machine 02 to loosen or displace, affecting its normal operation. However, the design of the present embodiment may keep the fan machine 02 stable under various complex use environments, reduce wear, tear and failures caused by vibration, and thus improve reliability of the entire refrigerator.

As illustrated in FIG. 15, in the installation structure of the fan machine 02 of the present embodiment, the limit groove 63 may play a role in defining the movable space of the limit arm 241. In a direction towards the refrigeration cavity 04, a height/depth of the limit groove 63 may be greater than the thickness of the matched limit arm 241. When the fan machine 02 needs to be telescoped, such as adjusting item layout in the refrigeration cavity 04, if the items touch the fan machine 02 or the refrigerator is subjected to external vibration, the external force acting on the fan machine 02 may push the fan machine 02. Since the limit arm 241 is located in the matched limit groove 63, and the height/depth of the limit groove 63 in the direction towards the refrigeration cavity 04 is greater than the thickness of the limit arm 241, the limit arm 241 may move in this direction. The fan machine 02 may be connected to the limit arm 241 through the bracket, such that the entire fan machine 02 may be telescoped with the movement of the limit arm 241 in the limit groove 63. The telescopic movement of the fan machine 02 may be carried out within a range defined by the limit groove 63, which may ensure the directionality and stability of the fan machine 02 during the telescopic process.

In some embodiments, a guide hole 242 may be defined on the bracket 24 of the fan machine 02. The guide hole 242 may play a critical role in a process of connecting the entire fan machine 02 to the wall of the mounting cavity 6 of the door 12. A shape and size of the guide hole 242 may match a guide column 62 on the bottom wall of the mounting cavity 6. The shape of the guide hole 242 may be circular, square, or other suitable geometric shapes, and an internal size of the guide hole 242 may be slightly greater than an external size of the guide column 62, so as to ensure that the guide column 62 may pass through smoothly while maintaining a certain fitting accuracy. The bottom wall of the mounting cavity 6 may be provided with the guide column 62. The guide column 62 may be a structure protruding from the bottom wall of the mounting cavity 6, and an overall size of the guide column 62 may be designed according to the installation requirements of the fan machine 02 and the overall structure of the refrigerator. The guide column 62 may be adapted to the guide hole 242, and may have a smooth surface, so as to reduce friction during a threading process and ensure a smooth installation process.

When installing the fan machine 02, first, as described earlier, insert two limit arms 241 on one side of the bracket 24 into the limit grooves 63 with greater depth on one side of the mounting cavity 6. During this process, as the bracket 24 moves, after the limit arms 241 on this side are inserted in place, continue to move the bracket 24 towards another side of the mounting cavity 6, such that the limit arms 241 on the another side of the bracket 24 are inserted into the limit grooves 63 on the another side. In this process, the guide hole 242 may gradually align with the guide column 62. When the guide hole 242 and the guide column 62 are fully aligned, the guide column 62 may pass through the guide hole 242 accurately. In this way, the installation of the fan machine 02 in the mounting cavity 6 may be completed.

The present embodiment may use the cooperation between the guide hole 242 and the guide column 62, so as to improve the installation accuracy of the fan machine 02. During the installation process, the guide hole 242 and the guide column 62 may provide precise positioning guidance for the fan machine 02, enabling the fan machine 02 to be accurately installed in the mounting cavity 6.

After the installation process is completed, the guide column 62 may pass through the guide hole 242 and provides additional support for the fan machine 02. This may effectively prevent the fan machine 02 from displacing or shaking in the mounting cavity 6 during usage of the refrigerator, especially when the refrigerator is subjected to vibration or jolts (such as during a transportation process of the portable refrigerator), thereby increasing the reliability of the entire refrigerator.

The door 12 is equipped with the fan machine 02, and a normal operation of the fan machine 02 may require connection to a power supply or control system of the cabinet 11. For this purpose, as illustrated in FIG. 14, a wire-passing hole 621 for wires of the fan 23 to pass through may be defined on the guide column 62 in the present embodiment. A size of the wire-passing hole 621 may be designed according to diameters and quantity of the wires of the fan 23, ensuring that the wires may pass through smoothly without being too loose to cause shaking during usage. The inner wall of the wire-passing hole 621 may be smooth, which may effectively avoid wear on an outer skin of the wires during the wire-passing process. The wire-passing hole 621 may be circular, elliptical, or other shapes suitable for wire layout.

In the present embodiment, the wire-passing hole 621 may be integrated into the guide column 62. When installing the fan machine 02, the wires may pass through in an orderly manner through the wire-passing hole 621 of the guide column 62, the space may be saved, since there is no need to define a separate channel or set a special wire slot for the wires. The wires may be arranged compactly along the guide column 62 through the wire-passing hole 621, making the internal structure of the door 12 more compact and concise.

In some implementations, as illustrated in FIG. 14, the fan 23 may include a fan body 231 and an outer cover 232. The fan body 231 may be connected to the bracket 24, and the outer cover 232 may cover the fan body 231. In some embodiments, the fan body 231 and the bracket 24 may be connected by snaps. Specifically, a number of snaps may be provided on an edge of the fan body 231, and corresponding snap slots matching the snaps may be defined on the bracket 24. This connection approach may be simple and convenient. During an installation process, only by aligning the snaps with the snap slots and press them together, the fan body 231 may be enabled to firmly fixed on the bracket 24. Optionally, the fan body 231 and the bracket may be connected by screws. Specifically, screw holes may be defined at matched positions on the fan body 231 and the bracket 24, and the two may be fixed together using appropriate screws. This connection approach may have a high reliability. The fan body 231 and the bracket 24 may also be connected by pins. Specifically, a number of pin holes may be defined on the edge of the fan body 231, and corresponding pins matching the pin holes may be provided on the bracket 24. During the installation process, only by aligning the pin holes with the pins and pressing them together, the fan body 231 may be firmly fixed onto the bracket 24.

In the present embodiment, the outer cover 232 may cover the fan body 231 and play a role in protecting the fan body 231 and guiding the air flow. An air outlet 2321 may be defined on the outer cover 232. The air outlet 2321 may have a mesh structure. The mesh air outlet 2321 may not only prevent foreign objects from entering an interior of the fan 23 and protect the blades of the fan 23 from damage, but also allow air flow to spread evenly into the refrigeration cavity 04.

Air inlets 2322 may also be defined on the outer cover 232. The air inlets 2322 may be in communication with the air outlet 2321 through the mounting cavity 6. A plurality of air inlets 2322 may be defined, and the plurality of air inlets 2322 may be distributed around the air outlet 2321. In this way, the air may be allowed to enter the fan 23 along a plurality of directions, thereby increasing an air intake volume. The plurality of air inlets 2322 surrounding the air outlet 2321 may make the air flow entering the fan 23 more uniform and stable, avoiding a reduction of air volume or idling of the fan 23 caused by insufficient air intake, thereby ensuring a normal operation of the fan 23 and a good air-cooling effect.

For those skilled in the art, it may be obvious that, the present disclosure may not be limited to the details of the aforementioned exemplary embodiments, and may be implemented in other specific forms without departing from the spirit or basic characteristics of the present disclosure. Therefore, from any point of view, the embodiments may be regarded as exemplary and non-restrictive. The scope of the present disclosure is defined by the claims rather than the aforementioned description. Therefore, all changes falling within the meaning and scope of equivalent elements of the claims are included in the present disclosure.

The aforementioned descriptions may be only the implementation approaches of the present disclosure, and may not thus limit the patent scope of the present disclosure. Any equivalent structure or equivalent process transformation made by using the contents of the description and drawings of the present disclosure, or directly or indirectly application in other related technical fields, may be similarly included in the patent protection scope of the present disclosure.

1. A vehicle refrigerator, comprising:
a cabinet, defining a refrigeration cavity and a first opening; wherein the first opening is in communication with the refrigeration cavity;
a door, movably over the first opening;
a fan machine, arranged on a side of the door close to the refrigeration cavity; and
a refrigeration assembly, mounted on the cabinet, and configured to cool the refrigeration cavity.

2. The vehicle refrigerator as claimed in claim 1, wherein
an inner wall of the door defines a recess, the recess is in communication with the refrigeration cavity, and the fan machine is at least partially arranged in a mounting cavity defined in the recess.

3. The vehicle refrigerator as claimed in claim 2, wherein
the fan machine is spaced apart from a side wall of the recess, to define a first air duct; the first air duct is in communication with the refrigeration cavity.

4. The vehicle refrigerator as claimed in claim 3, wherein
the fan machine comprises an axial flow fan; the axial flow fan is spaced apart from a bottom wall of the recess to define a second air duct; the second air duct is in communication with an air vent of the axial flow fan and with the first air duct.

5. The vehicle refrigerator as claimed in claim 3, wherein
the fan machine comprises a centrifugal fan; the side wall of the recess is arranged at an obtuse angle with a bottom wall of the recess, so that an inner diameter of the recess gradually increases along a direction from the bottom wall towards the refrigeration cavity.

6. The vehicle refrigerator as claimed in claim 3, wherein
the vehicle refrigerator further comprises a first baffle; the first baffle is movably connected to an inner wall of the door or to the fan machine; the first baffle selectively covers at least part of an opening of the first air duct, wherein the opening is on a side of the first air duct close to the refrigeration cavity.

7. The vehicle refrigerator as claimed in claim 2, wherein
the vehicle refrigerator further comprises a second baffle; the second baffle covers an opening of the recess; the fan machine is arranged in the recess; and
an air-intake grille is arranged at an outer periphery of the second baffle; the air-intake grille is in communication with the recess; an air outlet hole is defined in a middle of the second baffle, and the air outlet hole is in communication with an air outlet of the fan machine.

8. The vehicle refrigerator as claimed in claim 1, wherein
the vehicle refrigerator further comprises an inductive sensor; the inductive sensor is arranged on one side of the door, and configured to control start and stop of the fan machine.

9. The vehicle refrigerator as claimed in claim 1, wherein
the vehicle refrigerator further comprises a second inductive sensor and a second electronic control device; the second inductive sensor is arranged on an inner edge of the door, and is configured to control start and stop of the second electronic control device.

10. The vehicle refrigerator as claimed in claim 7, wherein
the vehicle refrigerator further comprises a sealing gasket ring; the sealing gasket ring is arranged between the air outlet of the fan machine and the air outlet hole, and is configured to isolate the air-intake grille from the air outlet hole.

11. The vehicle refrigerator as claimed in claim 2, wherein
the vehicle refrigerator further comprises an ultraviolet lamp and/or a semiconductor auxiliary cooling fin; the ultraviolet lamp and/or the semiconductor auxiliary cooling fin are arranged in the recess; and the ultraviolet lamp is sleeved on an outside of the fan machine.

12. The vehicle refrigerator as claimed in claim 7, wherein
the fan machine is at least partially spaced apart from a side wall of the recess to define a first air duct; the air outlet hole is defined in a region where the fan machine is arranged in contact with the second baffle; the air outlet hole is in communication with the air outlet of the fan machine and with the refrigeration cavity.

13. The vehicle refrigerator as claimed in claim 4, wherein
an air inlet and an air outlet of the axial flow fan are arranged in a straight line parallel to a rotation axis of a blade of the axial flow fan.

14. The vehicle refrigerator as claimed in claim 1, wherein
the fan machine comprises a dual fan; the dual fan comprises:
a turbine fan, arranged in an interior of the dual fan;
a blade fan, arranged in a reserved slot in a middle of the turbine fan;
a first drive motor, in transmission connection with the blade fan; and
a second drive motor, in transmission connection with the turbine fan;
wherein a rotational speed of the blade fan is greater than or equal to that of the turbine fan.

15. The vehicle refrigerator as claimed in claim 14, wherein
a transmission shaft of the blade fan passes through a middle bearing of the turbine fan, and is in transmission connection with the first drive motor.

16. The vehicle refrigerator as claimed in claim 14, wherein
the turbine fan is in transmission connection with the second drive motor through a transmission gear disc, the transmission gear disc is arranged at an upper end of the turbine fan.

17. The vehicle refrigerator as claimed in claim 1, wherein
an inner wall of the door defines a mounting cavity; an opening of the mounting cavity faces the refrigeration cavity; and
the fan machine is mounted in the mounting cavity and partially extending out of the opening of the mounting cavity.

18. The vehicle refrigerator as claimed in claim 17, wherein
the fan machine is movably connected to the door, configured to extend through the opening into the refrigeration cavity, and configured to retract into the mounting cavity through the opening.

19. The vehicle refrigerator as claimed in claim 18, wherein
the fan machine comprises a bracket and a fan, the fan is connected to the bracket;
the bracket is, in the mounting cavity, movably connected to the door.

20. The vehicle refrigerator as claimed in claim 19, wherein
the fan machine further comprises an elastic member;
an end of the elastic member is connected to the bracket; and, another end of the elastic member is connected to a cavity wall of the mounting cavity.
